(19) United States
(12) Patent Application Publication
(10) Pub. No.: US 2013/0188220 A1
(43) Pub. Date: Jul. 25, 2013

(54) IMAGE FORMING APPARATUS AND COMPUTER

(71) Applicant: Katsunori Suzuki, Shizuoka-ken (JP)

(72) Inventor: Katsunori Suzuki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/710,987

(22) Filed: Dec. 11, 2012

Related U.S. Application Data
(60) Provisional application No. 61/587,219, filed on Jan. 17, 2012.

(51) Int. Cl. G06K 15/02

(52) U.S. Cl. CPC G06K 15/1801
USPC 358/1.15

(57) ABSTRACT

In accordance with an embodiment, an image forming apparatus comprises a display unit, a display unit, a control unit and an image forming unit. The display unit displays a preview of the image of an object to be printed. The input unit accepts the designation of an area from user for the preview image displayed on the display unit. The control unit divides the area of the image of the object to be printed such that takes the area in the designated area as an area to be printed or a non-print area, the other area as a non-print area or an area to be printed. The mage forming unit forms the image of the object to be printed on a sheet in accordance with the division by the control unit.

### CROSS-REFERENCE TO RELATED APPLICATIONS

This application is based upon and claims the benefit of priority from U.S. Provisional Application No. 61/587,219 filed on Jan. 17, 2012; the entire contents of which are incorporated herein by reference.

### FIELD

Embodiments described herein relate to a technique for carrying out a print setting on an image forming apparatus.

### BACKGROUND

There is provided an image forming apparatus which scans the original of an object to be printed when copying or printing an original sheet to generate electronic data and displays the electronic data for preview before carrying out a copying or printing operation. The user confirms the content previewed and determines whether or not to carry out a copying operation.

Moreover, sometimes, the user desires to copy only part of a single surface of the original sheet but not the whole surface of the original sheet. In this case, before copying the desired part, the user needs to cover the other area of the object to be copied with a white sheet to make the other area in a blank state. A user interface for printing or copying part of a sheet is not provided by the conventional image forming apparatus having a preview function.

### BRIEF DESCRIPTION OF THE DRAWINGS

FIG. 1 is a diagram showing a structural example of an image forming apparatus.

FIG. 2 is a flowchart exemplarily illustrating the actions of an image forming apparatus.

FIG. 3A is a diagram showing an example of an original image displayed for preview before being printed.

FIG. 3B is a diagram showing an example of an area designated by the user using a measurer.

FIG. 4A is a diagram showing an example of a preview display in which a right upper pattern is selected.

FIG. 4B is a diagram showing an example of a preview display in which a left upper pattern is selected.

FIG. 5A is a diagram showing an example of an area designated by the user using a circular shape.

FIG. 5B is a diagram showing an example of an area designated by the user using a rectangular shape.

FIG. 5C is a diagram showing an example of a designated area manually drawn by the user.

FIG. 6 is a diagram showing an example of an operation screen for a selection on a printing position on a sheet.

FIG. 7 is a diagram showing an example of an operation screen for the user to designate a magnification/reduction power and a deployment mode.

FIG. 8A is a diagram showing an example of designation on areas to be printed in a plurality of pages.

FIG. 8B is a diagram showing an example of the copy state of a first page when the area shown in FIG. 8A and a ‘2 in 1’ setting are designated.

FIG. 8C is a diagram showing an example of the copy state of a first page when the area shown in FIG. 8A and a ‘4 in 1’ setting are designated.

FIG. 9 is a schematic diagram showing an example of a printing system.

### DETAILED DESCRIPTION

In accordance with an embodiment, an image forming apparatus comprises a display unit, a display unit, a control unit and an image forming unit. The display unit displays a preview of the image of an object to be printed. The input unit accepts the designation of an area from user for the preview image displayed on the display unit. The control unit divides the area of the image of the object to be printed such that takes the area in the designated area as an area to be printed or a non-print area, the other area as a non-print area or an area to be printed. The mage forming unit forms the image of the object to be printed on a sheet in accordance with the division by the control unit.

In accordance with an embodiment, an image forming apparatus displays the original pages of an object to be copied for preview, accepts an area designation of the user and prints the designated area only. Area designation refers to the following actions:

1. The user designates a measurer displayed on a preview screen as unit.

2. The user selects a specified pattern. The specified patterns include the upper part, the lower part, the left upper part, the left lower part, the right upper part and the right lower part of a sheet. The size of the area of the specified pattern is changeable;

3. A graphic (quadrangle, circle or freehand) is draw on the preview screen and take the drawn area as the area of the object to be printed. The graphic can be magnified or reduced.

In accordance with an embodiment, an image forming apparatus may also designate a deployment (Nin1). When the size of a designated area is below 1/N of a page, the designated area is copied without being changed in size to copy Nin1. When the size of a designated area is greater than 1/N of a page, the designated area is copied in a reduced size corresponding to the designation of Nin1. Moreover, the image forming apparatus provided in the embodiment can overlap the borders of Nin1 in one page on the preview screen.

The embodiment is described below with reference to accompanying drawings.

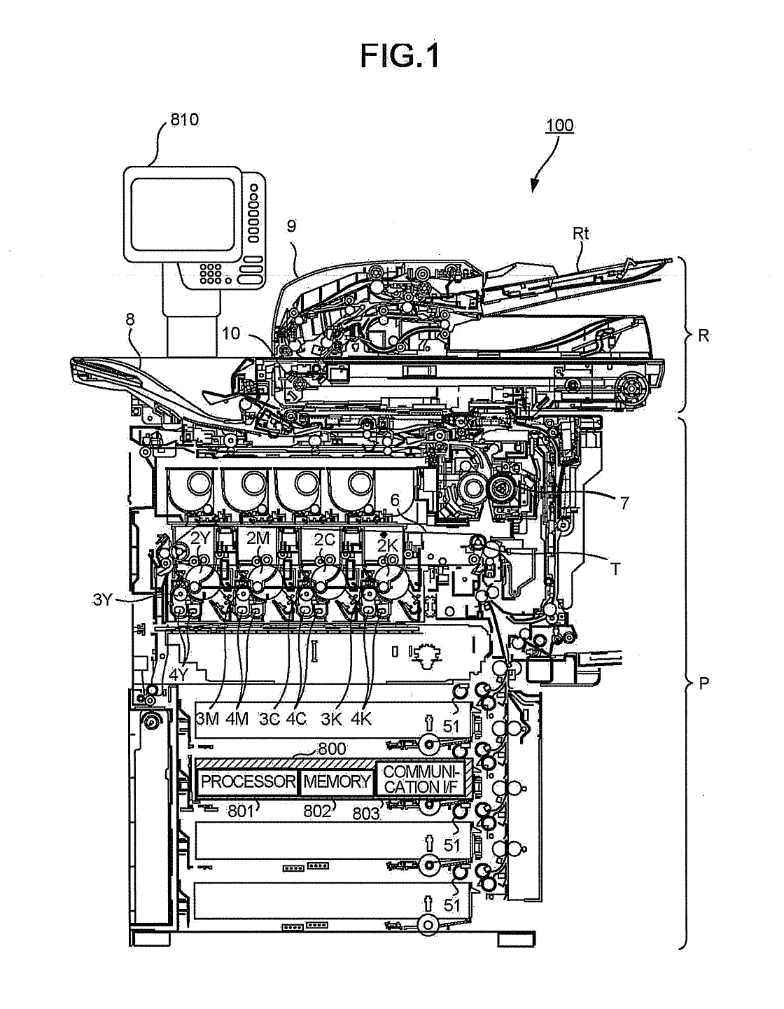

FIG. 1 is a diagram roughly showing the longitudinal section of an image forming apparatus MFP (Multi Function Peripheral) according to an embodiment. As shown in FIG. 1, the image forming apparatus 100 comprises a reading unit R and an image forming unit P.

The reading unit R has a function of scanning and reading images of an original sheet and an original book. The reading unit R is provided with a scanning optical system 10 having a plurality of reflecting lenses and an imaging member and an automatic document feeder (ADF) 9 for automatically feeding an original to a designated place. The original which is automatically fed to an original tray Rt by the automatic document feeder 9 and the image of an original placed on an original table (not shown) are read by the scanning optical system 10.

The image forming unit P has the following function of forming a developer image on a sheet based on the image read by the reading unit R from the original or the image data sent to the image forming apparatus 100 from a peripheral. Moreover, the image forming unit P comprises photosensitive members 2Y-2K, developing rollers 3Y-3K, mixers 4Y-4K, an intermediate transfer belt 6, a fixing apparatus 7 and a discharge tray 8.

The image forming apparatus 100 comprises a control panel (control unit) 800 for comprehensively controlling each hardware in the apparatus forming apparatus. The control panel 800 comprises a processor 801, a memory 802 and a communication I/F (Interface) 803. The processor 801 is an operation processing apparatus such as a CPU (Central Processing Unit) or an MPU (Micro Processing Unit). The processor 801 realizes various processing of the image forming apparatus 100 and achieves various functions by loading and executing the program prestored in the memory 802.

The memory 802 is a memory unit consisting of nonvolatile memory apparatuses including an RAM (Random Access Memory) serving as a primary memory apparatus, a flash memory and and a hard disk drive. The communication I/F 803 is a unit for controlling the data transmission with a peripheral.

Further, the image forming apparatus 100 has a control panel 810, which comprises: a touch panel type input unit for accepting the instruction of the user; and a flat plate type display unit for displaying the content or information being processed for the user and displaying the image of the object to be printed for preview before a print processing is started.

A copying processing is roughly described below as an example of a processing carried out by the image forming apparatus 100 provided in the embodiment. First, a sheet picked up by a pickup roller 51 is fed into a sheet conveying path. The sheet fed into the sheet conveying path is conveyed to a given conveying direction by means of a plurality of pairs of rollers.

Then, the images of the sheet originals sequentially and automatically conveyed by the automatic original feeder 9 are read by the scanning optical system 10.

Next, the control panel 800 carries out a specific image processing on the image data read by the reading unit R from the original. Then, electrostatic latent images of the processed image data are formed on the photosensitive surfaces of photosensitive members 2Y, 2M, 2C and 2K for transferring developer images (Y (yellow), M(magenta), C(cyan), K (black)) onto a sheet.

Next, the developer mixed by the mixers 4Y-4K of the developing apparatus is fed by developing rollers (the called magnet roller) 3Y-3K to the photosensitive members 2Y-2K on which electrostatic latent images are formed. In this way, the electrostatic latent images formed on the photosensitive surfaces of the photosensitive members are developed.

In this way, the developer images formed on the photosensitive members are transferred to the belt surface of the intermediate transfer belt 6 (the called primary transfer) and conveyed, through the rotation of the intermediate transfer belt, to a given secondary transfer position T to be transferred on a sheet conveyed thereto.

The developer images transferred on the sheet are thermally fixed by the fixing apparatus 7. The developer images are conveyed into a conveying path by a plurality of conveying rollers through the thermally fixed sheet and then sequentially discharged to the discharge tray 8.

Additionally, the actions carried out in a print processing are the same as the actions above except that the data of the object to be printed sent from a computer is acquired through the communication I/F 803.

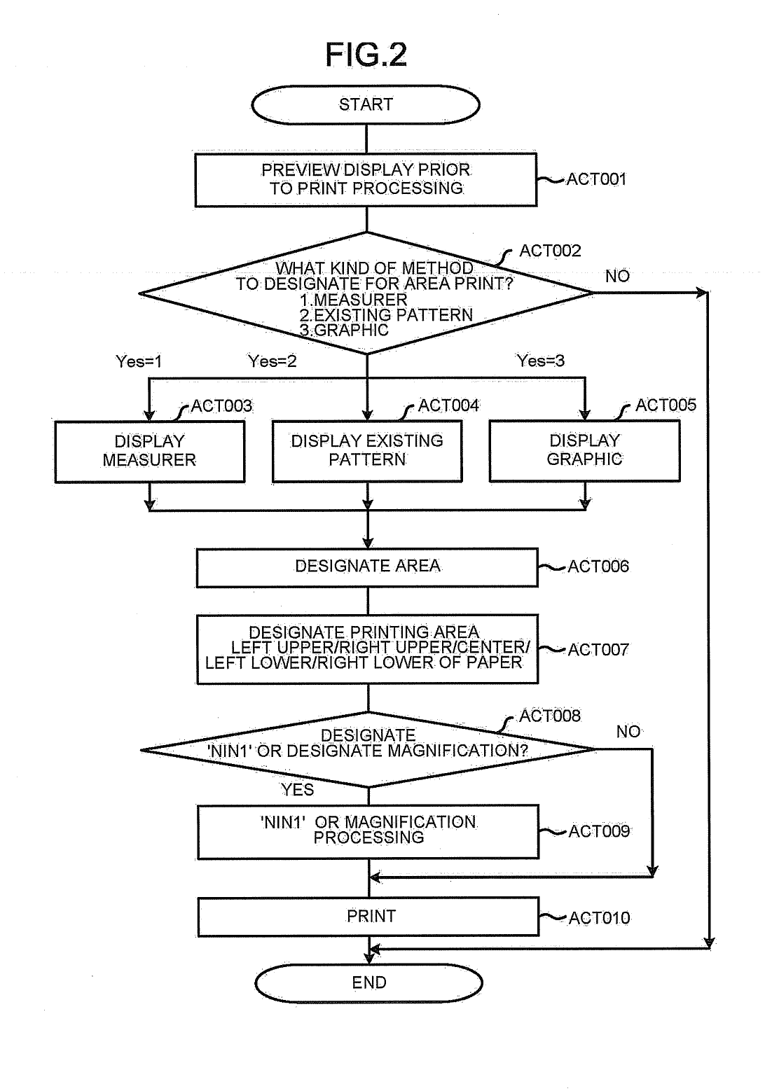

Before carrying out a copying or printing processing, the image forming apparatus 100 displays the image of an object for preview so that the user can select an area to be copied or printed. FIG. 2 is a flowchart exemplarily illustrating the actions carried out by the image forming apparatus 100 at this time. The actions shown in the flowchart of FIG. 2 are carried out by the processor 801 of the control panel 800 by executing the program that is prestored in the memory, Or by each hardware acting in accordance with the instruction of the processor 801.

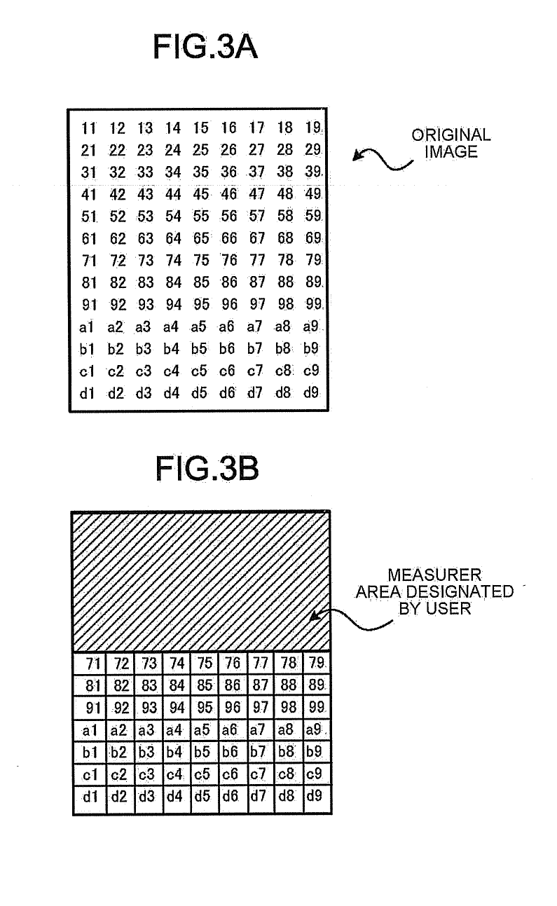

After printing data is stored in the memory 802 through a scanning on the original or through the communication I/F 803, the control panel 810 displays the image data of the object to be printed for preview (ACT001). FIG. 3A shows an example of the preview image displayed here. The image data is original image data.

The control panel 810 displays dialog ‘select area designation method’ and acquires designation method information from the user.

If the area designation method is measurer (ACT 002, YES=1), then the control panel 810 overlaps grid lines that forms a measurer on the image data exemplarily shown in FIG. 3A in accordance with the instruction of the processor 801 and then displays the overlapped image data (ACT 003). The user touches the screen displayed on the control panel 810 with fingertips to designate the area of each measurer (ACT 006). The control panel 810 detects the touch, acquires the detected position and sends the position information to the processor 801. The processor 801 controls the control panel 810 by displaying the measurer containing the position information in gray color.

FIG. 3B shows a state in which the measurer carries out a designation in this way. FIG. 3B shows an example of the designation on the area of the object to be printed by the user using upper measurers.

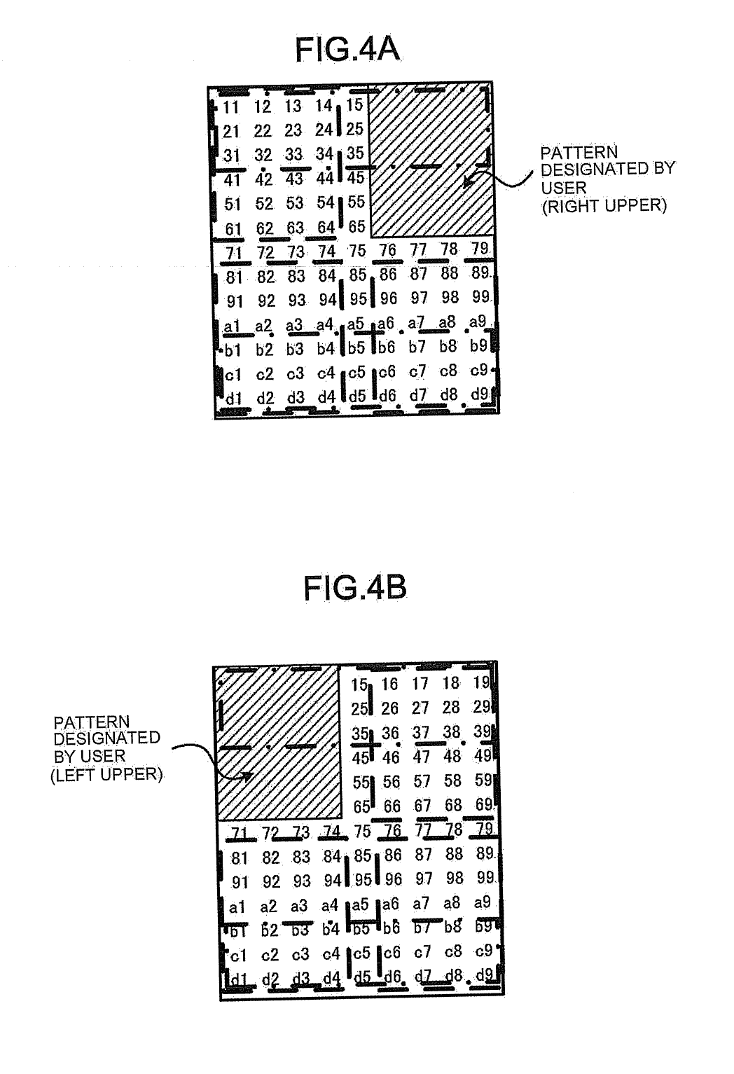

On the other hand, if a specific pattern is selected in ACT 002 (ACT 002, Yes=2), the processor 801 acquires, from the memory 802 the information related to specific upper, lower, left upper, left lower, right upper and right lower areas that are defined in advance, and instructs the control panel 810 to overlaps the specific pattern on the area and displays the overlapped area in gray color (ACT 004). The user selects any specific area displayed on the control panel 810 (ACT 006). FIG. 4A and FIG. 4B show examples of the display of the control panel 810 at this time. FIG. 4A shows an example of the display when the right upper pattern is selected, and FIG. 4B shows an example of the display when the left upper pattern is selected. By pressing an area in the displayed specific pattern for a long time, the user can release the designation on the specific area. Moreover, the specific area can be designated again by pressing a rectangular box for a long time in a release state.

Further, each specific area may be scaled up or scaled down through the fingertip operation (pinch operation) of the user.

On the other hand, if a graphic is selected in ACT 002 (ACT002, Yes=3), the control panel 810 displays dialog ‘select circle, quadrangle or freehand’ to guide the user to select an optional shape. The processor 810 instructs the control panel 810 to display the shape that is selected by the user through the dialog, and the control panel 810 displays the designated shape at a predetermined position in a predetermined size (ACT005).

The user designates an area by touching the shape displayed (ACT006). The shape representing an area may be moved through a drag operation of the user and magnified/reduced through a pinch operation.

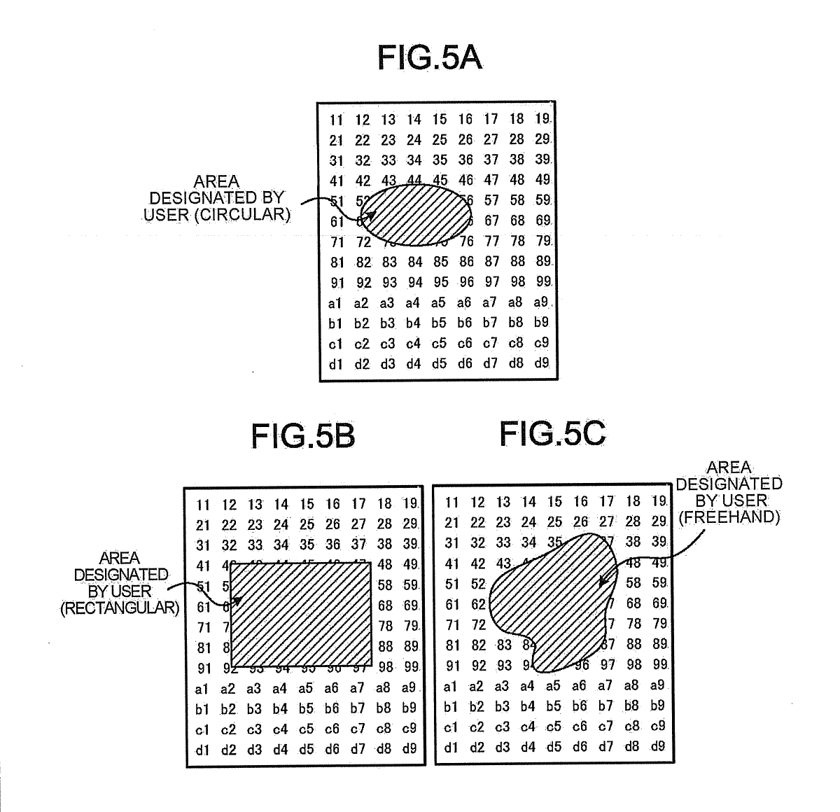

FIG. 5A is a diagram showing an area designated by the user using a circular shape, and FIG. 5B is a diagram showing showing an area designated by the user using a rectangular shape, FIG. 5C shows an area designated by freehand. As to the freehand, the control panel 810 detects the position of the fingertip of the user, and the processor 801 acquires the track coordinate of the fingertip and sends a drawing instruction to the control panel 810 to designate an area. Moreover, the shape of a closed area is formed by connecting the starting point and the ending point of the freehand. The mentioned shapes may be moved through a drag operation of the user, or a colored area may be scaled up/down through a pinch operation.

Moreover, in ACT 006, the processor 801 sets the area designated by the user to be an area to be printed and the other area to be area not to be printed, thereby divideing the areas. For example, the processor 801 only stores the coordinate values in the measurer or the graphic area designated by the user in the memory 802 and ignores the storage of other values, thereby divideing an area to be printed from an area not to be printed. Further, the flag map corresponding to each pixel position of the image of the object to be printed may be set in the memory 802 (for example, flag map 0 represents ‘not print’ and flag map 1 represents ‘print’), the processor 801 divides an area to be printed from an area not to be printed by setting the flag map in a designated area to be 0 or 1. There are also various other division methods.

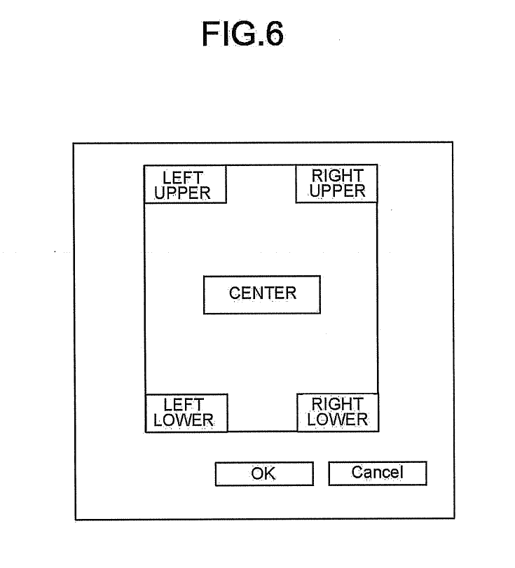

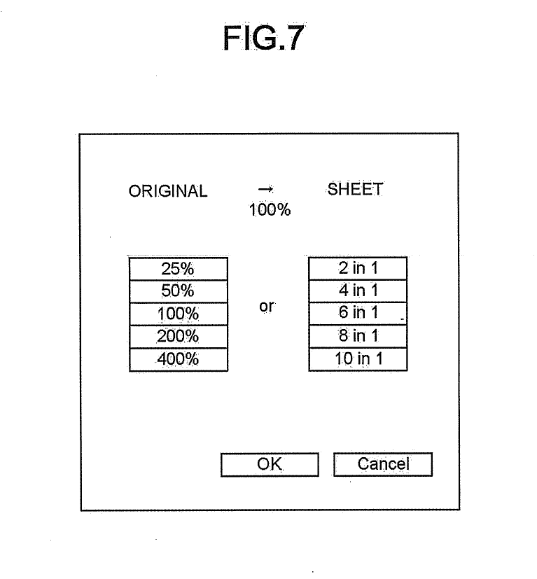

After the area of the object to be printed is designated in this way, the control panel 810 displays the operation screen shown in FIG. 6 to enable the user to designate a printing position on the sheet (ACT 007). For example, if the user presses a ‘center’ button, then the area designated in ACT 006 is printed on the center part of the sheet. If the user presses a ‘right lower’ button, then the area designated in ACT 006 is printed on the right lower part of the sheet.

After the printing position on the sheet is determined, the control panel 810 displays an operation screen (shown in FIG. 6) for the user to select the magnification/reduction power and a deployment setting (Nin1 setting) (ACT 009). In the embodiment, no deployment setting is accepted while a magnification/reduction power is being set, and vice verse. Moreover, in the case of a magnification/reduction power setting, the user selects a magnification/reduction power of 25%-400% for the original, and in the case of a deployment setting, the user selects ‘2in1’ (print 2 pages on one sheet)-‘10in1’ (print 10 pages on one sheet).

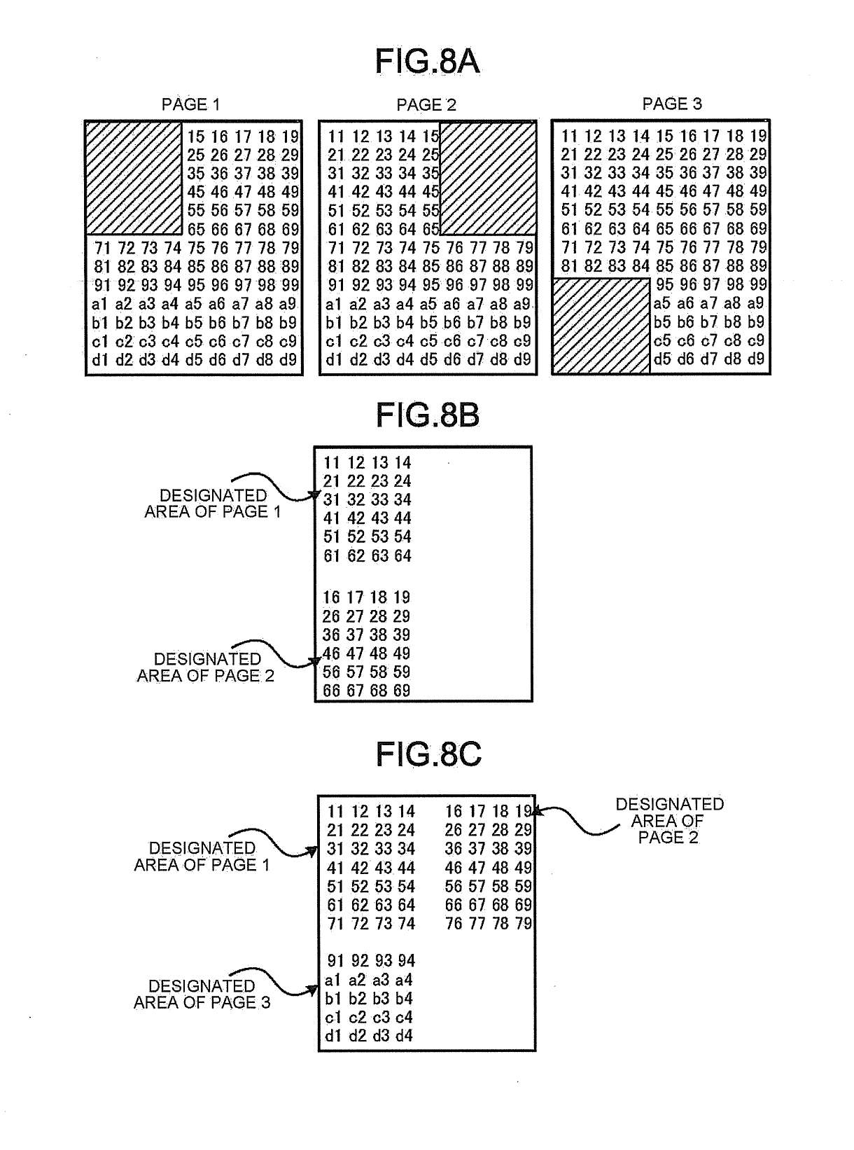

The setting of a magnification/reduction power is the same as the prior art, and a printing operation is carried out according to the power designated by the user. The deployment setting in the embodiment is further described with reference to FIG. 8A-FIG. 8C. In this example, as shown in FIG. 8A, the user designates a left upper area on the preview image of a first page and a right upper area on the preview image of a second page. Moreover, the user designates a left lower area on the preview image of a third page.

A designation on ‘2in1’ is described after the area designation shown in 8A is accepted. In the case of a designation on ‘2in1’, the processor 801 copies the printing areas without changing the sizes of the printing areas when the maximum size of the designated areas is below ½ page, and the image forming unit P prints two pages on one sheet (refer to FIG. 8B). On the other hand, when the maximum size of the designated areas is not below ½ page, the processor 801 prints the printing areas in a reduced size, and the image forming unit P prints two pages on one page. In addition, the third page is printed on the next sheet in the example shown in FIG. 8B.

The designation on ‘4in1’ is described below. In the case a designation on ‘4in1’, the processor 801 copies the printing areas without changing the sizes of the printing areas when the maximum size of the designated area is below ¼ of a page, and the image forming unit P prints four pages on one page (refer to FIG. 8C). On the other hand, when the maximum size of the designated areas is not below ¼ of a page, the processor 801 prints the printing area in a reduced size, and the image forming unit P prints four pages on one page.

Thus, in this embodiment, when the size of the designated areas is below 1/N of a page, the printing of Nin1 are carried out without being changed in size. Moreover, when the size of the designated areas is greater than 1/N of a page, the designated areas are copied in a reduced size corresponding to the designation of Nin1.

At last, the image forming unit P prints the object to be printed by printing the area designated by the user and keeping the other area blank (ACT010). Here, the processor 810 only extracts the data in the user-designated area serving as the image data of the object to be printed to regenerate image data and outputs the image data (signal) to the image forming unit P. The image forming apparatus P receives the newly generated image data (signal) and forms an image on the sheet according to the signal.

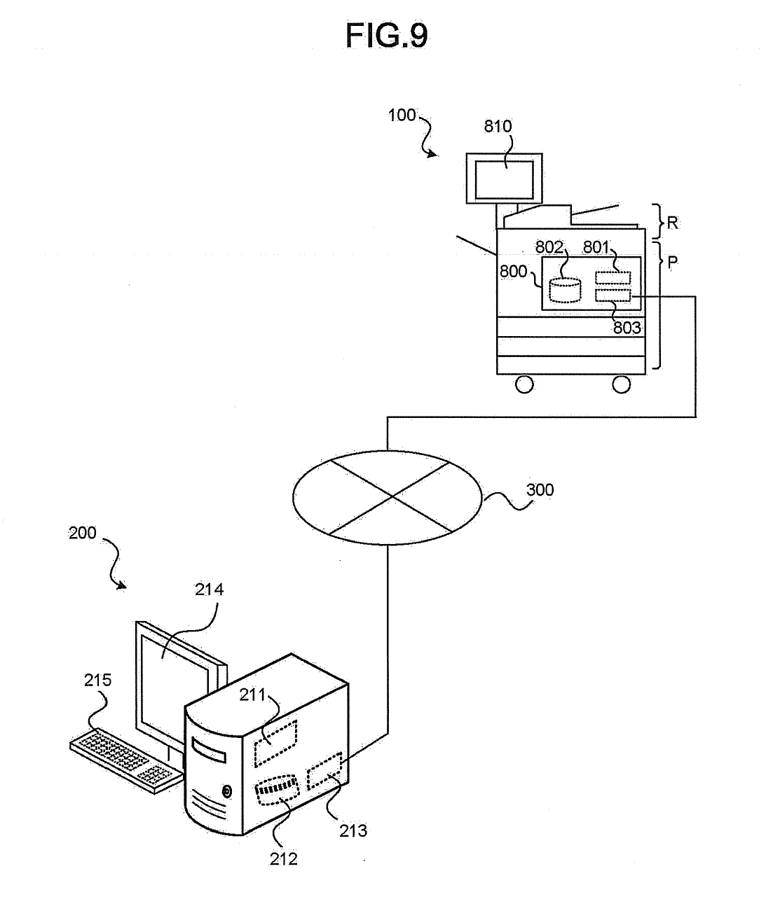

The description given so far illustrates the designation of the control panel 810 of the image forming apparatus 100 on an area, however, the print processing may be as follows: the area of an object to be printed is designated by a computer to which printing data is sent. FIG. 9 is a schematic diagram exemplarily showing a printing system in which an image forming apparatus 100 is connected with a computer 200 through a network 300. The computer 200 comprises a processor 211 having the same function with the image forming apparatus 100, a memory 212, a communication I/F 213, a monitor 214 functioning as a display unit and a keyboard 215 functioning as an input unit. The input unit may also be provided with a mouse.

A print driver program which is called when printing data is sent to the image forming apparatus 100 is imported into the memory 212 in advance. The processor 211 calls and executes the driver program when carrying out a print processing. Moreover, the processor 211 controls the memory 212, the monitor 214, the keyboard 215 and the mouse in accordance with codes of the driver program to execute the actions ACT001-ACT009 shown in FIG. 2.

After ACT009 is executed, the processor 211 generates printing data by taking the determined area as an object to be printed and keeping the other area blank and sends the printing data to the image forming apparatus 100 through the communication I/F 213. The image forming apparatus 100 forms an image on the sheet using the printing data received (ACT010).

An area to be printed is designated using a graphic or a measurer in the example above. However, an area not to be printed may be designated, in this case, the area different from the designated area is printed. Moreover, the pattern of the area may be a rectangle, a circle or a freehand or any other pattern.

In this embodiment, the functions of the present invention are prerecorded in the apparatus, however, the present invention is not limited to this, the same functions may also be downloaded to the apparatus from a network or stored in a recording medium and then installed in the apparatus. The recording medium refers to any recording medium (e.g. CD-ROM) that is capable of storing programs and readable to the apparatus. Further, the function achieved by an installed or downloaded program can also be achieved by the cooperation with an OS (Operating System) installed in the apparatus.

As stated above, in accordance with the technique provided herein, the user can easily designate any part of the image of an object to be printed to be printed or not to be printed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a display unit configured to display a preview of the image of an object to be printed;
an input unit configured to accept the designation of an area from user for the preview image displayed on the display unit;
a control unit configured to divide the area of the image of the object to be printed such that takes the area in the designated area as an area to be printed or a non-print area, the other area as a non-print area or an area to be printed; and
an mage forming unit configured to form the image of the object to be printed on a sheet in accordance with the division by the control unit.

2. The image forming apparatus according to claim 1, wherein
the area designated by the user is rectangular; and
the display unit displays the area by overlapping the area on the preview image.

3. The image forming apparatus according to claim 1, wherein
the area designated by the user is circular; and
the display unit displays the area by overlapping the area on the preview image.

4. The image forming apparatus according to claim 1, wherein
the display unit displays the preview image by overlapping grid lines of a measurer on the preview image; and
the input unit accepts the designation of the user on the area by taking the measurer as unit.

5. The image forming apparatus according to claim 1, wherein
the area is specified a plurality of positions and sizes previously;
the display unit displays the specified area by overlapping the specified area on the preview image; and
the input unit accepts the specified area should be selected.

6. The image forming apparatus according to claim 1, wherein
the area is a closed area designated by the track of the hand drawing of the user; and
the display unit displays the area by overlapping the area on the preview image.

7. The image forming apparatus according to claim 1, wherein
the image forming unit forms the images in the area designated in each page on one surface of a sheet in the case where an area is respectively designated on a plurality of pages.

8. A computer, comprising:
a display unit configured to display a preview of the image of an object to be printed;
an input unit configured to accept the designation of an area from user for the preview image displayed on the display unit; and
a control unit configured to divide the area of the image of the object to be printed such that takes the area in the designated area as an area to be printed or a non-print area, the other area as a non-print area or an area to be printed.

9. The computer according to claim 8, wherein
the area designated by the user is rectangular; and
the display unit displays the area by overlapping the area on the preview image.

10. The computer according to claim 8, wherein
the area designated by the user is circular; and
the display unit displays the area by overlapping the area on the preview image.
